(19) United States
(12) Patent Application Publication
(10) Pub. No.: US 2009/0064654 A1
(43) Pub. Date: Mar. 12, 2009

(54) Turbine engine with modulated combustion and reheat chambers

(75) Inventors: Joseph Kirzhner, Simpsonville, SC (US); Daniel Hynum, Simpsonville, SC (US); Sal Albert Leone, Scotia, NY (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 11/898,257

(22) Filed: Sep. 11, 2007

(51) Int. Cl. F02C 3/06

(52) U.S. Cl. 60/39.17; 60/774

(57) ABSTRACT

A turbine engine includes a compressor, a combustor fluidly connected to the compressor and a first turbine operated by a combustion product formed in the first combustor. The turbine engine also includes a reheat chamber in which air, fuel, and exhaust gases from the first turbine are ignited to form a combustion product used to drive a second turbine. The engine further includes a controller that regulates at least one of an amount of fuel and compressed air delivered to the combustor and an amount of fuel, compressed air and exhaust gases delivered to the reheat chamber based on at least one turbine engine parameter measured by a sensor.

### BACKGROUND OF THE INVENTION

The present invention pertains to the art of turbine engines and, more particularly, to a turbine engine having a modulated combustor and a modulated reheat chamber.

In general, gas turbine engines combust a fuel/air mixture to release heat energy to form a high temperature gas stream that is channeled to a turbine section via a hot gas path. More specifically, a compressor compresses incoming air to a high pressure. The high pressure air is delivered to a combustion chamber to mix with fuel and form a combustible mixture. The combustible mixture is then ignited to form a high pressure, high velocity gas which is delivered to a turbine. The turbine converts thermal energy from the high temperature, high velocity gas stream to mechanical energy that rotates a turbine shaft. The turbine shaft is coupled to and drives the compressor and also other machinery such as an electrical generator.

After converting the thermal energy from the high pressure, high velocity gases to mechanical energy, exhaust gases are formed and vented from the turbine. The exhaust gases can either be expelled to ambient air or used to preheat the combustion chamber and increase turbine efficiency. Exhaust gases are also channeled to other combustion or reheat chambers, combined with air and additional fuel, and ignited to provide power for another turbine. Optimizing turbine efficiency at various operating conditions, particularly at base load, is always a concern

### BRIEF DESCRIPTION OF THE INVENTION

In accordance with one aspect, the invention provides a turbine engine. The turbine engine includes a compressor, a first combustor fluidly connected to the compressor and a first turbine operated by a combustion product from the first combustor. The turbine engine also includes a reheat chamber in which air, fuel and exhaust gases from the first turbine are ignited to form a combustion product. The turbine engine further includes a second turbine operated by the combustion product formed in the reheat chamber and a controller. The controller regulates at least one of an amount of fuel and compressed air delivered to the first combustor, and an amount of fuel, compressed air and exhaust gases delivered to the reheat chamber based on at least one turbine engine parameter as measured by a sensor.

In accordance with another aspect, the present invention provides a method of operating a turbine engine. The method includes delivering compressed air from a compressor to a first combustor, mixing the compressed air with fuel, igniting the compressed air and fuel to form a combustion product and operating a first turbine on the combustion product from the first combustor. The method further includes delivering exhaust gases from the first turbine to a reheat chamber to mix with air from the compressor and additional fuel to form a combustible mixture. The combustible mixture is ignited to form a combustion product which is used to operate a second turbine. At least one of the amount of fuel and compressed air delivered to the first combustor, and the amount of fuel, compressed air and exhaust gases delivered to the reheat chamber are dependent upon a measured operational parameter of the turbine engine.

It should be appreciated that the present invention optimizes turbine efficiency at various operating conditions based upon measured and calculated operational parameters. In any case, additional objects, features and advantages of the present invention will become more readily apparent from the following detailed description of illustrated aspects when taken in conjunction with the drawings wherein like reference numerals refer to corresponding parts in the several views.

### BRIEF DESCRIPTION OF THE DRAWINGS

FIG. 1 is a diagrammatic representation of a multi-shaft turbine engine including a modulated combustion chamber and multiple modulated reheat chambers constructed in accordance with an aspect of the present invention.

### DETAILED DESCRIPTION OF THE INVENTION

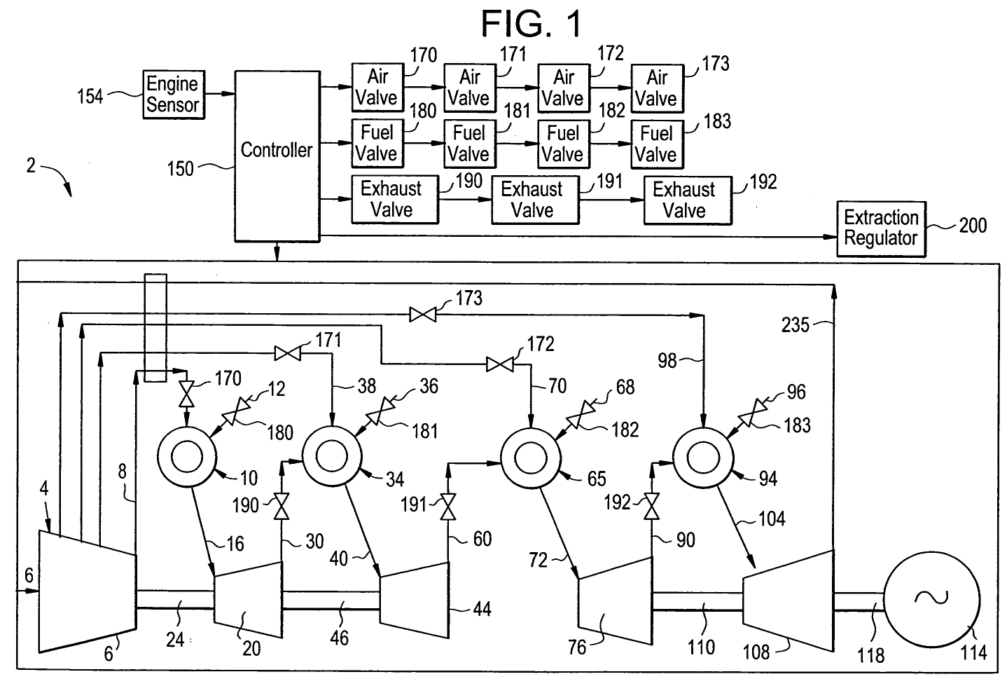

With initial reference to FIG. 1, a turbine engine constructed in accordance with the present invention is generally indicated at 2. Engine 2 includes a rotary compressor 4 that compresses ambient or atmospheric air 6 to form a high pressure air 8. High pressure air 8 is passed to a first or main combustor 10 to mix with fuel 12 before being ignited to form high pressure, high temperature combustion products 16. High pressure, high temperature combustion products 16 are used to drive a first turbine 20 which, in the embodiment shown, is a gas generating turbine. First turbine 20 is primarily employed to drive compressor 4 via a shaft 24.

High pressure air 8 supplied to combustor 10 is more than what is required for complete combustion of fuel 12. Thus, exhaust gas 30, output from turbine 20, contains excess air which is delivered to a first reheat chamber 34. Once in first reheat chamber 34, excess air in exhaust gas 30 mixes with additional fuel 36 and high pressure air 38 from compressor 4 and is ignited to form a high pressure, high temperature combustion product 40. In a manner similar to that describe above, combustion product 40 is used to drive a second turbine 44 that is operatively connected to first turbine 20 via a shaft 46.

High pressure air 38 and an exhaust gas 30, from first turbine 20, is more than what is required to fully combust additional fuel 36. Thus, an exhaust gas 60, output from second turbine 44, contains excess air which is delivered to a second reheat chamber 65. Once in second reheat chamber 65, exhaust gas 60 mixes with additional fuel 68 and high pressure air 70 from compressor 4 and ignited to form a high pressure, high temperature combustion product 72. Combustion product 72 is used to drive a third turbine 76 which, in the embodiment shown, is a power turbine.

In a manner similar to that described above, high pressure air 70 and exhaust gas 60 is more than what is required to fully combust fuel 68. Thus, an exhaust gas 90, output from third turbine 76, contains excess air which is delivered to a third reheat chamber 94. Once in third reheat chamber 94, exhaust gas 90 mixes with additional fuel 96 and high pressure air 98 from compressor 4 and ignited to form a high pressure, high temperature combustion product 104. Combustion product 104 is used to drive a fourth turbine 108 which is operatively connected to third turbine 76 via a shaft 110 and to a power generating device 114 via a shaft 118.

In accordance with one aspect of the invention, engine 2 includes a controller 150 that selectively modulates air and fuel delivery to each of main combustor 10 and air, fuel and exhaust gas delivery to reheat chambers 34, 65 and 94 based on engine operating parameters as determined by an engine sensor 154. More specifically, controller 150 receives feedback from sensor 154 and compares the feedback to baseline operating parameters stored in a memory (not shown) to determine an offset or difference value. At this point, controller 150 selectively adjusts fuel and/or air delivery to combustor 10 and/or air, fuel and/or exhaust gas delivery to reheat chambers 34, 65 and 94. Sensor 154 can be configured to measure one or more operating parameters of engine 2. For example, sensor 154 could be an exhaust temperature sensor, a hot gas path temperature sensor, a kilowatt (kW) sensor, a flow meter, a shaft torque sensor, an ambient air temperature sensor and a speed sensor. Moreover, sensor 154 could be multiple sensors configured to monitor multiple operating parameters of engine 2 and provide feedback to controller 150.

In any case, controller 150 is coupled to a first plurality of valves 170-173 configured to selectively control air delivery from compressor 4 to respective ones of main combustor 10 and reheat chambers 34, 65 and 94. Controller 150 is also coupled to a second plurality of valves 180-183 which are configured to selectively control fuel delivery to respective ones of main combustor 10 and reheat chambers 34, 65 and 94. In addition, controller 150 is coupled to a third plurality of valves 190-192 which are configured to selectively control exhaust gas delivery to reheat chambers 34, 65 and 94. As noted above, with this arrangement, control 150 compares feedback received from sensor(s) 154 with baseline parameters or optimal conditions e.g., operational conditions, e.g., speed, load, etc. and ambient conditions, e.g., air temperature, humidity, etc., to regulate a position of one or more of values 170-173, 180-183 and 190-192 to deliver air, fuel and/or exhaust gas to optimize operation of engine 2.

In accordance with another aspect of the present invention, controller 150 is coupled to an extraction regulator 200. Extraction regulator 200 selectively regulates from which compressor extraction, air is delivered to main combustor 10, reheat chamber 34, reheat chamber 65 and/or reheat chamber 94 based on the measured engine operating parameters. More specifically, if upon comparing actual operating and/or ambient conditions with base line measurements, controller 150 determines that a greater amount of air is needed by, for example, main combustor 10, a higher pressure extraction is selected. If controller 150 determines that lesser amounts of air are required, lower pressure extractions can be used. In this manner, controller 150 optimizes air delivery to increase engine operating efficiency.

At this point it should be appreciated that the various aspects of the present invention optimize turbine engine efficiency at various operating conditions by selectively controlling air and fuel input to a combustor and air, fuel and exhaust gas to one or more reheat chambers based upon measured engine operating parameters. In addition, turbine efficiency is also improved by regulating from which compressor extraction, air is withdrawn and delivered to the combustor or reheat chamber(s). Although described with reference to illustrated aspects of the present invention, it should be readily understood that various changes and/or modifications can be made without departing from the spirit thereof. For instance although shown in connection with operating a power generating device, engine 2 could also be used to operate various other types of machinery, such as pumps and the like. In addition, while shown controlling a main combustor and multiple reheat chambers, it should be readily understood that the present invention could be employed to operate a single combustor and a single reheat chamber. Furthermore, it should be understood that the engine operating parameter can be determined through direct measurement or though calculation. Finally, while the engine is shown as including multiple shafts, the present invention is equally applicable to singe shaft turbines. In general, the invention is only intended to be limited by the scope of the following claims.

1. A turbine engine comprising:
a compressor;
a combustor fluidly connected to the compressor, said combustor containing a combustion product formed by ignition of air from the compressor component and fuel;
a first turbine operated by the combustion product formed in the first combustor, said first turbine outputting exhaust gases;
at least one reheat chamber fluidly connected to the compressor component and the first turbine component, said at least one reheat chamber containing a combustion product formed by ignition of the exhaust gases of the first turbine, air from the compressor and additional fuel;
a second turbine operated by the combustion product formed in the at least one reheat chamber, said second turbine outputting exhaust gases;
at least one sensor positioned to determine at least one engine operating parameter; and
a controller selectively regulating at least one of an amount of fuel and air delivered to the combustor and an amount of additional fuel, air and exhaust gases from the first turbine delivered to the at least one reheat chamber based on the at least one engine operating parameter.

2. The turbine engine according to claim 1, further comprising: a second reheat chamber fluidly connected to the compressor and the second turbine, said second reheat chamber containing a combustion product formed by ignition of the exhaust gases from the second turbine, air and additional fuel.

3. The turbine engine according to claim 2, further comprising: a third turbine operated by the combustion product formed in the second reheat chamber, said third turbine outputting exhaust gases.

4. The turbine engine according to claim 3, wherein the controller selectively regulates at least one of an amount of additional fuel, air and exhaust gases from the second turbine delivered to the second reheat chamber based upon the at least one engine operating parameter.

5. The turbine engine according to claim 4, further comprising: a third reheat chamber fluidly connected to the compressor and the third turbine, said third reheat chamber containing a combustion product formed by ignition of the exhaust gases from the third turbine, air and additional fuel.

6. The turbine engine according to claim 5, further comprising: a fourth turbine operated by the combustion product formed in the third reheat chamber, said fourth turbine outputting exhaust gases.

7. The turbine engine according to claim 6, wherein the controller selectively regulates at least one of an amount of additional fuel, air and exhaust gases from the third turbine delivered to the third reheat chamber based upon the at least one turbine engine operating parameter.

8. The turbine engine according to claim 1, further comprising: an extraction control operatively connected to the controller, said controller selecting a particular compressor extraction from which to draw air based on the at least one engine operating parameter.

9. The turbine engine according to claim 1, further comprising: at least one fuel valve operatively connected to the controller, said at least one fuel valve being adapted to selectively control an amount of fuel delivered to the combustor.

10. The turbine engine according to claim 9, wherein the at least one fuel valve includes another fuel valve operatively connected to the controller, said another fuel valve being adapted to selectively control the amount of fuel delivered to the reheat chamber.

11. The turbine engine according to claim 1, further comprising: at least one air valve operatively connected to the controller, said at least one air valve being adapted to selectively control an amount of compressor air delivered to the combustor.

12. The turbine engine according to claim 11, wherein the at least one air valve includes another air valve operatively connected to the controller, said another air valve being adapted to selectively control the amount of compressor air delivered to the reheat chamber.

13. The turbine engine according to claim 1, further comprising: at least one exhaust gas valve operatively connected to the controller, said at least one exhaust gas valve being adapted to selectively control an amount of exhaust gas from the first turbine delivered to the reheat chamber.

14. The turbine engine according to claim 1, wherein the sensor is at least one of a exhaust temperature sensor, kW meter, a flow meter, a torque sensor, a hot gas path temperature sensor, a speed sensor and an ambient air temperature sensor.

15. A method of operating a turbine engine comprising:
delivering compressed air from a compressor to a first combustor;
mixing the compressed air with fuel;
igniting the compressed air and fuel to form a combustion product in the first combustor;
operating a first turbine component on the combustion product from the first combustor;
delivering exhaust gases passing from the first turbine to a reheat chamber to mix with air from the compressor and additional fuel to form a combustible mixture;
igniting the combustible mixture in the reheat chamber to form a combustion product;
operating a second turbine on the combustion product from the reheat chamber;
determining at least one operational parameter of the engine; and
selectively regulating at least one of an amount of fuel and compressed air delivered to the combustor and an amount of additional fuel, compressed air and exhaust gas from the first turbine delivered to the reheat chamber based on the determined operational parameter.

16. The method of claim 15, further comprising:
delivering exhaust gases from the second turbine to a second reheat chamber to mix with air from the compressor and additional fuel to form a combustible mixture;
igniting the combustible mixture in the second reheat chamber to form a combustion product;
operating a third turbine on the combustion product from the second reheat chamber; and
selectively regulating at least one of an amount of additional fuel and compressed air delivered to the second reheat chamber based on the determined parameter.

17. The method of claim 16, further comprising:
delivering exhaust gases from the third turbine to a third reheat chamber to mix with air from the compressor and additional fuel to form a combustible mixture;
igniting the combustible mixture in the third reheat chamber to form a combustion product;
operating a fourth turbine on the combustion product from the third reheat chamber; and
selectively regulating at least one of an amount of additional fuel and compressed air delivered to the third reheat chamber based on the determined operational parameter.

18. The method of claim 15, further comprising: selecting one of a plurality of compressor extractions for delivering air to at least one of the combustor and reheat chamber based on the determined operating parameter.

19. The method of claim 15, further comprising:
comparing the at least one measured operating parameter to a baseline parameter to determine an offset value; and
selectively regulating the at least one of an amount of fuel and compressed air delivered to the at least one of the combustor and the reheat chamber based on the offset value.
